(19) United States
(12) Patent Application Publication
(10) Pub. No.: US 2026/0371349 A1
(43) Pub. Date: Nov. 19, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Weiqi Sun, Beijing, Haidian District (CN); Jing Wang, Beijing, Haidian District (CN); Lan Chen, Beijing, Haidian District (CN)

(73) Assignee: NTT DOCOMO, INC., Tokyo (JP)

(21) Appl. No.: 19/155,423

(22) PCT Filed: Feb. 24, 2023
(86) PCT No.: PCT/JP2023/006823

§ 371 Date: Aug. 11, 2025

(51) Int. Cl. H04W 72/21; H04L 5/00

(52) U.S. Cl. CPC H04W 72/21; H04L 5/0051

(57) ABSTRACT

A terminal according to an aspect of the present disclosure includes: a receiving section that receives configuration information of a type 1 configured grant and two sounding reference signal (SRS) resource sets; and a control section that controls a single-DCI multi-panel simultaneous transmission physical uplink shared channel (PUSCH) using space division multiplexing (SDM) or a single frame network (SFN). An aspect of the present disclosure enables a single-DCI multi-panel simultaneous transmission PUSCH to be appropriately controlled in a case where a configured grant is applied.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement, and the like of the LIE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile,” “5G+ (plus),” “6th generation mobile communication system (6G),” “New Radio (NR),” “3GPP Rel. 15 (or later versions),” and the like) are also under study.

### CITATION LIST

### Non-Patent Literature

Non-Patent Literature 1:3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, NR), a terminal (user terminal, User Equipment (UE)) is possible to use one of a plurality of panels (beams) for uplink (UL) transmission. However, studies have not sufficiently been made on control for a case that simultaneous transmission using a plurality of panels is supported.

For example, in a case where a configured grant is applied, regarding a single-downlink control information (DCI) multi-panel simultaneous transmission physical uplink shared channel (PUSCH), what configuration/control is to be made has not sufficiently been studied. Unless this is made clear, system performance reduction such as a decrease in throughput may be caused.

In view of this, the present disclosure has one object to provide a terminal, a radio communication method, and a base station that enable appropriate control of the single-DCI multi-panel simultaneous transmission PUSCH in a case where the configured grant is applied.

### Solution to Problem

A terminal according to an aspect of the present disclosure includes: a receiving section that receives configuration information of a type 1 configured grant and two sounding reference signal (SRS) resource sets; and a control section that controls a single-DCI multi-panel simultaneous transmission physical uplink shared channel (PUSCH) using space division multiplexing (SDM) or a single frame network (SEN).

Advantageous Effects of Invention An aspect of the present disclosure enables a single-DCI multi-panel simultaneous transmission PUSCH to be appropriately controlled in a case where a configured grant is applied.

### BRIEF DESCRIPTION OF DRAWINGS

FIG. 1 is a diagram to show an example of association between precoder types and TPMI indices.

FIG. 2 FIGS. 2A to 2C are each a diagram to show an example of transmission with a plurality of panels.

FIG. 3 FIGS. 3A to 3C are each a diagram to show another example of transmission with a plurality of panels.

FIG. 4 is a diagram to show application of an SRS resource set indication field in Rel. 17.

FIG. 5 is a diagram to show an example of an SRS resource set indication field to be applied to single-panel transmission (STRP) and to dynamic switching between the single-panel transmission and an STxMP SDM scheme.

FIG. 6 is a diagram to show an example of associations in Option 2 and Option 3 according to a first embodiment.

FIG. 7 is a diagram to show an example of DCI according to a third embodiment.

FIG. 8 is a diagram to show an example of a schematic structure of a radio communication system according to one embodiment.

FIG. 9 is a diagram to show an example of a structure of a base station according to one embodiment.

FIG. 10 is a diagram to show an example of a structure of a user terminal according to one embodiment.

FIG. 11 is a diagram to show an example of a hardware structure of the base station and the user terminal according to one embodiment.

FIG. 12 is a diagram to show an example of a vehicle according to one embodiment.

### DESCRIPTION OF EMBODIMENTS

(Dynamic Grant-based Transmission and Configured Grant-based Transmission (Type 1 and Type 2)

For NR, dynamic grant-based transmission and configured grant-based transmission are under study.

The dynamic grant-based transmission is UL transmission using an uplink shared channel (for example, a PUSCH (Physical Uplink Shared Channel)) based on downlink control information (DCI) (UL grant) or is DL transmission using a downlink shared channel (for example, a PDSCH (Physical Downlink Shared Channel)) based on DCI (DL assignment).

The configured grant-based transmission is UL transmission using an uplink shared channel (for example, PUSCH) based on configuration information (which may be referred to as, for example, configured grant, configured UL grant, or the like) configured by a higher layer or is DL transmission using a downlink shared channel (for example, PDSCH) based on configuration information (for example, sps-config) configured by a higher layer.

In the configured grant-based transmission, UL resources are already allocated to a UE so that the UE can autonomously perform UL transmission by using the configured resources, and thus low latency communication is expected to be achieved.

The dynamic grant-based transmission may be referred to as, for example, dynamic grant-based PUSCH, UL transmission with dynamic grant, PUSCH with dynamic grant, UL transmission with UL grant, UL grant-based transmission, UL transmission scheduled (for which transmission resources are configured) by dynamic grant, or the like.

The configured grant-based transmission may be referred to as, for example, configured grant-based PUSCH, UL transmission with configured grant, PUSCH with configured grant, UL transmission without UL grant, UL grant-free transmission, UL transmission scheduled (for which transmission resources are configured) by configured grant, or the like.

Configured grant-based DL transmission may be referred to as semi-persistent scheduling (SPS). Configured grant-based UL transmission may be referred to as UL SPS. In the present disclosure, “configured grant” may be interchangeably interpreted as “SPS,” “SPS/configured grant,” or the like.

For the configured grant-based transmission, several types (such as type 1 and type 2) are applied.

For configured grant type 1 transmission (type 1 configured grant), parameters (which may be referred to as configured grant-based transmission parameters, configured grant parameters, or the like) to be used for the configured grant-based transmission may be configured for a UE by using higher layer signaling only.

For configured grant type 2 transmission (type 2 configured grant), configuration information for a configured grant (parameters, configured grant parameters) is configured for a UE by using higher layer signaling. In the configured grant type 2 transmission, at least a part of the configured grant parameters may be notified to a UE by using physical layer signaling (for example, downlink control information (DCI) for activation to be described below).

The configured grant parameters may be configured for a UE by using an information element “ConfiguredGrantConfig” of a higher layer (for example, RRC). The configured grant parameters may include, for example, information that specifies configured grant resources. The configured grant parameters may include information related to a configured grant index, a time offset, a periodicity, the number of times of repetition transmission of a transport block (TB) (the number of times of repetition transmission may be referred to as K), a redundancy version (RV) Sequence used for repetition transmission, the above-described timer, and the like, for example.

Here, the periodicity and the time offset may each be expressed in units such as symbols, slots, subframes, or frames. For example, the periodicity may be indicated in a certain number of symbols. The time offset may be indicated in an offset corresponding to a timing of a certain index (such as slot number=0 and/or system frame number=0), for example. The number of times of repetition transmission may be any integer such as 1, 2, 4, 8, or the like, for example. In a case where the number of times of repetition transmission is n (>0), a UE may transmit a certain TB by configured grant-based PUSCH transmission by using n times of transmission occasions.

In a case where the configured grant type 1 transmission is configured, a UE may judge that one or a plurality of configured grants are triggered. The UE may perform PUSCH transmission without any dynamic grant, by using configured resources for configured grant-based transmission (which may be referred to as configured grant resources, transmission occasions, or the like). Note that, even in a case where configured grant-based transmission is configured, when there is no data in a transmission buffer, the UE may skip the configured grant-based transmission.

In a case where the configured grant type 2 transmission is configured and a certain activation signal is notified, a UE may judge that one or a plurality of configured grants are triggered (or activated). The certain activation signal (for example, DCI for activation) may be DCI (PDCCH) with CRC (Cyclic Redundancy Check) scrambled by a certain identifier (for example, CS-RNTI (Configured Scheduling Radio Network Temporary Identifier)). Note that the DCI may be used for control such as deactivation and retransmission of a configured grant.

The UE may judge, based on the certain activation signal described above, whether to perform PUSCH transmission using configured grant resources configured by a higher layer. Based on DCI for deactivation of a configured grant or on expiration of a certain timer (elapse of a certain time), the UE may release (which may be referred to as deactivate or the like) a resource (PUSCH) corresponding to the configured grant.

A UE may perform PUSCH transmission without any dynamic grant, by using activated resources for configured grant-based transmission (which may be referred to as configured grant resources, transmission occasions, or the like). Note that, even in a case where configured grant-based transmission is activated (in an active state), when there is no data in a transmission buffer, the UE may skip the configured grant-based transmission.

Note that a dynamic grant and configured grant may each be referred to as an actual UL grant or DL assignment. In other words, the actual UL grant may be higher layer signaling (for example, an information element (IE) “ConfiguredGrantConfig”), physical layer signaling (for example, the certain activation signal described above), or any combination of them.

### PUSCH Precoder

For NR, it is under study that a UE supports at least one of codebook (CB) based transmission and non-codebook (NCB) based transmission.

For example, it is under study that the UE judges a precoder (precoding matrix) for at least one of CB based uplink shared channel (Physical Uplink Shared Channel (PUSCH)) transmission and NCB based PUSCH transmission by using at least a sounding reference signal (SRS) resource indicator (SRI).

In a case of CB based transmission, the UE may determine a precoder for PUSCH transmission, based on an SRI, a transmitted rank indicator (TRI), a transmitted precoding matrix indicator (TPMI), and the like. In a case of NCB based transmission, the UE may determine a precoder for the PUSCH transmission, based on the SRI.

The UE may be notified of the SRI, the TRI, the TPMI, and the like by using downlink control information (DCI). The SRI may be specified by an SRS Resource Indicator field (SRI field) of the DCI or may be specified by a parameter “srs-ResourceIndicator” included in an RRC information element “ConfiguredGrantConfig” for a configured grant PUSCH. The TRI and the TPMI may be specified by precoding information and number of layers field (“Precoding information and number of layers” field) of the DCI.

The UE may report UE capability information related to a precoder type and be configured, by a base station, with the precoder type based on the UE capability information by higher layer signaling. The UE capability information may be precoder type information to be used by the UE in PUSCH transmission (which may be indicated by an RRC parameter “pusch-TransCoherence”).

The UE may determine a precoder to be used for the PUSCH transmission, based on precoder type information (which may be indicated by an RRC parameter “codebookSubset”) included in PUSCH configuration information notified by higher layer signaling (“PUSCH-Config” information element of RRC signaling). The UE may be configured with a subset of a PMI specified by the TPMI, by codebookSubset.

Note that the precoder type may be specified by any of or a combination of at least two of full coherent (fully coherent, coherent), partial coherent, and non-coherent (non coherent) (which may be indicated, for example, by a parameter such as “fullyAndPartialAndNonCoherent” or “partialAndNonCoherent.”

Full coherent may mean that all the antenna ports to be used for transmission are synchronized (which may be expressed as being able to be matched in terms of phase, having the same precoder to be applied, and the like). Partial coherent may mean that some ports of the antenna ports to be used for transmission are synchronized but the ports and the other ports are not synchronized. Non-coherent may mean that the antenna ports to be used for transmission are not synchronized.

Note that a UE that supports the precoder type, full coherent, may be assumed to support the precoder types, partial coherent and non-coherent. A UE that supports the precoder type, partial coherent, may be assumed to support the precoder type, non-coherent.

The precoder type may be interpreted as coherency, PUSCH transmission coherence, a coherent type, a coherence type, a codebook type, a codebook subset, a codebook subset type, and the like.

The UE may determine a precoding matrix corresponding to the TPMI index obtained from DCI for scheduling UL transmission (for example, DCI format 0_1, this similarly applies below), from a plurality of precoders (which may be referred to as a precoding matrix, a codebook, and the like) for CB based transmission.

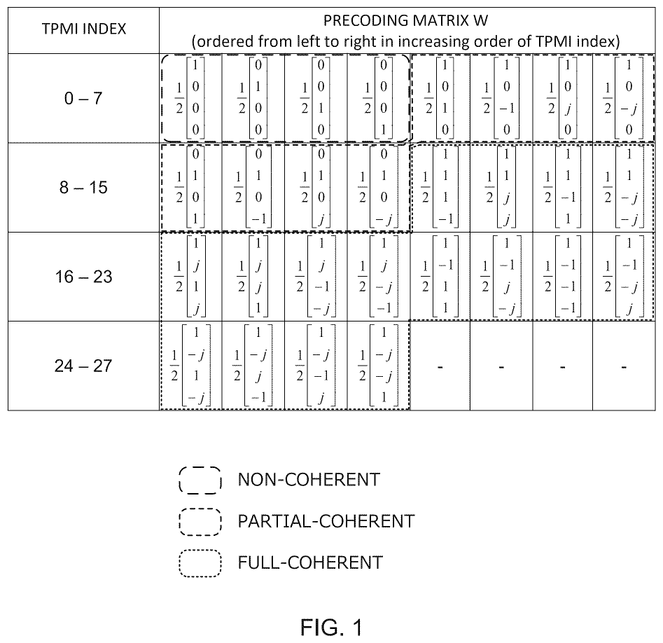

FIG. 1 is a diagram to show an example of association between precoder types and TPMI indices. FIG. 1 corresponds to a table of precoding matrices W for single-layer (rank 1) transmission using four antenna ports with DET-S-OFDM (Discrete Fourier Transform spread OFDM, with transform precoding enabled).

In FIG. 1, in a case where the precoder type (codebookSubset) is fullyAndPartialAndNonCoherent, a UE is notified of a TPMI of any one of 0 to 27, for single-layer transmission. In a case where the precoder type is partialAndNonCoherent, the UE is configured with a TPMI of any one of 0 to 11, for single-layer transmission. In a case where the precoder type is nonCoherent, the UE is configured with a TPMI of any one of 0 to 3, for single-layer transmission.

Note that, as shown in FIG. 1, a precoding matrix with only one element per column being other than 0 may be referred to as a non-coherent codebook. A precoding matrix with only a certain number of elements (not all elements) per column being other than 0 may be referred to as a partial-coherent codebook. A precoding matrix with none of the elements per column being 0 may be referred to as a full-coherent codebook.

The non-coherent codebook and the partial-coherent codebook may each be referred to as an antenna selection precoder. The full-coherent codebook may be referred to as a non-antenna selection precoder.

Note that, in the present disclosure, the partial-coherent codebook may correspond to a codebook (i.e., codebooks with TPMI=4 to 11, in a case of single-layer transmission with four antenna ports) obtained by excluding a codebook corresponding to a TPMI specified for a UE configured with a non-coherent codebook subset (for example, the RRC parameter “codebookSubset”=“nonCoherent”) from codebooks (precoding matrices) corresponding to TPMIs specified, by DCI, for codebook based transmission, for a UE configured with a partial-coherent codebook subset (for example, the RRC parameter “codebookSubset”=“partialAndNonCoherent”).

Note that, in the present disclosure, the full-coherent codebook may correspond to a codebook (i.e., codebooks with TPMI=12 to 27, in a case of single-layer transmission with four antenna ports) obtained by excluding a codebook corresponding to a TPMI specified for a UE configured with a partial-coherent codebook subset (for example, the RRC parameter “codebookSubset”=“partialAndNonCoherent”) from codebooks (precoding matrices) corresponding to TPMIs specified, by DCI, for codebook based transmission, for a UE configured with a full-coherent codebook subset (for example, the RRC parameter “codebookSubset” “fullyAndPartialAndNonCoherent”).

### Spatial Relation for SRS and PUSCH

The UE may receive information to be used for transmission of a reference signal for measurement (for example, sounding reference signal (SRS)) (SRS configuration information, for example, a parameter in an RRC control element “SRS-Config”).

Specifically, the UE may receive at least one of information related to one or a plurality of SRS resource sets (SRS resource set information, for example, an RRC control element “SRS-ResourceSet”) and information related to one or a plurality of SRS resources (SRS resource information, for example an RRC control element “SRS-Resource”).

One SRS resource set may be related to a certain number of SRS resources (may group the certain number of SRS resources).

Each SRS resource may be identified by an SRS resource indicator (SRI) or an SRS resource ID (Identifier).

The SRS resource set information may include an SRS resource set ID (SRS-ResourceSetId), a list of SRS resource IDs (SRS-ResourceId) used in the resource set, an SRS resource type, and information of SRS usage.

Here, the SRS resource type may indicate any one of a periodic SRS (P-SRS), a semi-persistent SRS (SP-SRS), and an aperiodic SRS (A-SRS, AP-SRS). Note that the UE may transmit a P-SRS and an SP-SRS periodically (or periodically after activation), and transmit an A-SRS on the basis of an SRS request of DCI.

Examples of the usage (RRC parameter “usage,” L1 (Layer-1) parameter “SRS-SetUse”) may include beam management (beamManagement), codebook based transmission (codebook (CB)), non-codebook based transmission (nonCodebook (NCB)), antenna switching (antennaSwitching), and the like. An SRS with codebook based transmission or non-codebook based transmission usage may be used to determine a precoder for codebook based or non-codebook based PUSCH transmission based on an SRI.

For example, in a case of codebook based transmission, the UE may determine a precoder for the PUSCH transmission, based on an SRI, a transmitted rank indicator (TRI), and a transmitted precoding matrix indicator (TPMI). In a case of non-codebook based transmission, the UE may determine a precoder for the PUSCH transmission, based on an SRI.

The SRS resource information may include an SRS resource ID (SRS-Resourceld), the number of SRS ports, an SRS port number, transmission Comb, SRS resource mapping (for example, time and/or frequency resource position, resource offset, resource periodicity, the number of times of repetition, the number of SRS symbols, SRS bandwidth, and the like), hopping related information, an SRS resource type, a sequence ID, spatial relation information for an SRS, and the like.

For a PUSCH, when codebook based transmission is used, two SRS resources may be configured for the UE by RRC, and one of the two SRS resources may be indicated for the UE by DCI (a certain field of one bit). For a PUSCH, when non-codebook based transmission is used, four SRS resources may be configured for the UE by RRC, and one of the four SRS resources may be indicated for the UE by DCI (a certain field of two bits). In order to use a spatial relation other than the two or four spatial relations configured by RRC, RRC reconfiguration is required.

### Multi-Panel Transmission

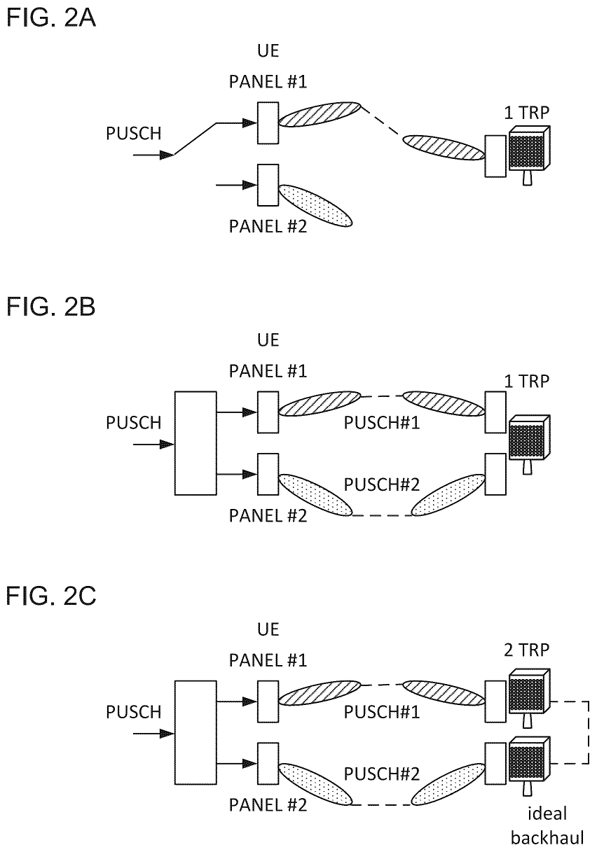

For a UE in Rel. 15 and Rel. 16, at one time point, only one beam and panel are used for UL transmission (FIG. 2A). For Rel. 17, in order to improve UL throughput and reliability, simultaneous UL transmission with a plurality of beams and a plurality of panels for one or more TRPs is under study.

For simultaneous UL transmission using a plurality of beams and a plurality of panels, reception by one TRP with a plurality of panels (FIG. 2B) or reception by two TRPs with ideal backhaul (FIG. 2C) is under study. A single PDCCH for scheduling of a plurality of PUSCHs (for example, simultaneous transmission of PUSCH #1 and PUSCH #2) is under study. It is under study that panel-specific transmission is supported and a panel ID is introduced.

A base station may configure or indicate panel-specific transmission for UL transmission, by using a UL TCI or panel ID. The UL TCI (UL TCI state) may be based on signaling similar to DL beam indication supported in Rel. 15. The panel ID may be implicitly or explicitly applied to transmission of at least one of a target RS resource or target RS resource set, a PUCCH, an SRS, and a PRACH. In a case where the panel ID is explicitly notified, the panel ID may be configured in at least one of a target RS, a target channel, and a reference RS (for example, DL RS resource configuration or spatial relation information).

### Multi-Panel UL Transmission Scheme

A multi-panel UL transmission scheme or multi-panel UL transmission scheme candidate may be at least one of the following schemes 1 to 3 (multi-panel UL transmission schemes 1 to 3). Only one of the schemes 1 to 3 may be supported. A plurality of schemes including at least one of the schemes 1 to 3 may be supported and one of the plurality of schemes may be configured for a UE.

### Scheme 1

Scheme 1 is coherent multi-panel UL transmission.

A plurality of panels may be synchronized with each other.

Layers are all mapped to every panel. A plurality of analog beams are indicated. An SRS resource indicator (SRI) field may be extended. In this scheme, up to four layers may be used for UL.

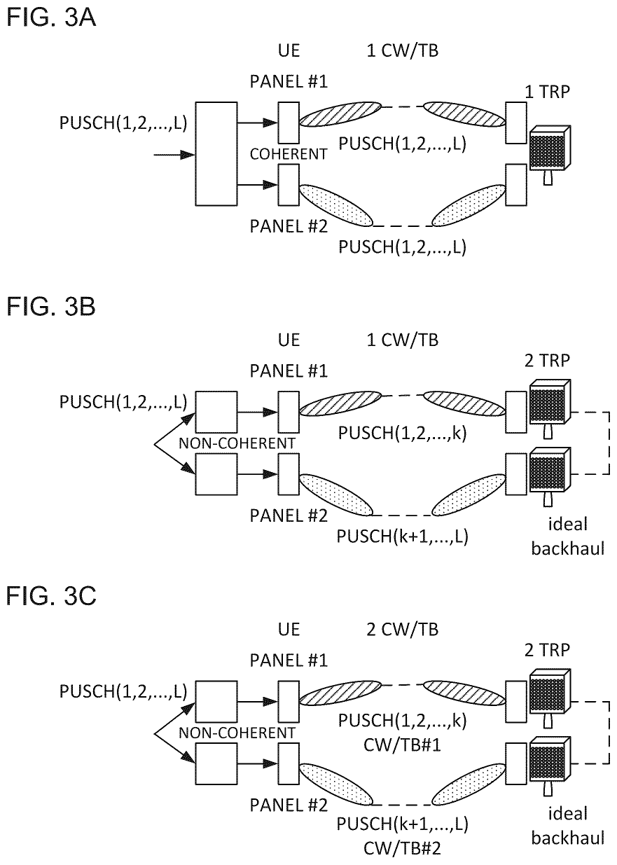

In an example of FIG. 3A, a UE maps one codeword (CW) or one transport block (TB) to L layers (PUSCHS (1, 2, . . . , L)) and transmits the L layers from two panels each. Panel #1 and panel #2 are coherent with each other. Scheme 1 allows gain due to diversity to be obtained. The total number of layers for the two panels is 2 L. In a case where the maximum value of the total number of layers is four, the maximum value of the number of layers in one panel is two.

### Scheme 2

Scheme 2 is non-coherent multi-panel UL transmission of one codeword (CW) or transport block (TB).

A plurality of panels may not need to be synchronized with each other. Different layers are mapped to different panels and to one CW or TB for PUSCHs from the plurality of panels. Layers corresponding to one CW or TB may be mapped to the plurality of panels. In this scheme, up to four layers or up to eight layers may be used for UL. In a case where up to eight layers are supported, this scheme may support one CW or TB using up to eight layers.

In an example of FIG. 3B, a UE maps one CW or one TB to K layers (PUSCHs (1, 2, . . . k)) and L-k layers (PUSCHs (k+1, k+2, . . . , L)), and transmits the k layers from panel #1 and transmits L-k layers from panel #2. Scheme 2 allows gain due to multiplexing and diversity to be obtained. The total number of layers for the two panels is L.

### Scheme 3

Scheme 3 is non-coherent multi-panel UL transmission of two CWs or TBS.

A plurality of panels may not need to be synchronized with each other. Different layers are mapped to different panels and to two CWs or TBs for PUSCHs from the plurality of panels. Layers corresponding to one CW or TB may be mapped to one panel. Layers corresponding to a plurality of CWs or IBs may be mapped to different panels. In this scheme, up to four layers or up to eight layers may be used for UL. In a case where up to eight layers are supported, this scheme may support up to four layers per CW or TB.

In an example of FIG. 3C, a UE maps CW #1 or TB #1, out of two CWs or two TBs, to k layers (PUSCHs (1, 2, . . . , k)) and maps CW #2 or TB #2 to L-k layers (PUSCHS (k+1, k+2, L)), and transmits the k layers from panel #1 and transmits L-k layers from panel #2. Scheme 3 allows gain due to multiplexing and diversity to be obtained. The total number of layers for the two panels is I.

### (Rel-17 TDM MTRP PUSCH)

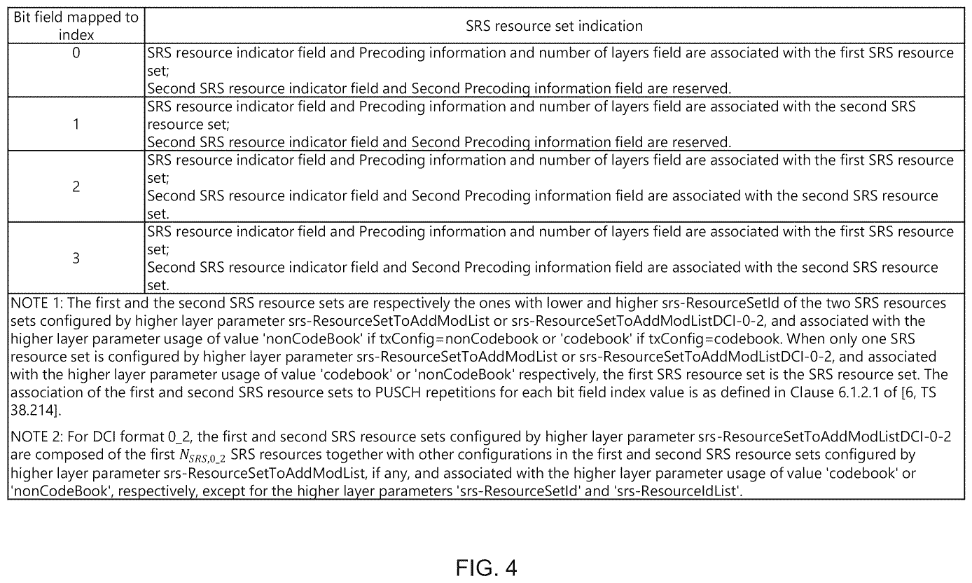

In Rel. 17, different PUSCH repetitions are associated with different beams/TRPs/SRS resource sets. For an Rel-17 TDM MIRP PUSCH, an SRS resource set indication field indicates dynamic switching between MTRP transmission and STRP transmission (FIG. 4). In a case where the codepoint “00” (index=0) or the codepoint “01” (index=1) is indicated, this corresponds to STRP, a first SRI field and a first TPMI field are applied, and a second SRI field and a second TPMI field are reserved. In a case where the codepoint “10” (index=2) or the codepoint “11” (index=3) is indicated, this corresponds to MTRP, and the first and second SRI fields and the first and second TPMI fields are applied.

### Items to be Studied for Rel. 18

For Rel-18 MIMO, support of 8Tx and support of multi-panel simultaneous transmission (Simultaneous Transmission across Multiple Panels (STxMP)) are under study. For example, it is studied to extend a UL DMRS, SRS, SRI, and TPMI (including codebook) that enable 8Tx UL operation supporting four layers or more per UE. Furthermore, subjected to Customer Premises Equipment (CPE)/Fixed Wireless Access (FWA)/on-board/industrial equipment (if applicable), assuming, mainly for FR2 and multi-TRP, up to two TRPs and up to two panels, studies are under way in order to facilitate multi-panel simultaneous transmission for UL throughput/reliability improvement.

A single-DCI multi-panel simultaneous transmission PUSCH scheme using space division multiplexing (Space Division Multiplexing (SDM) is under study. In this scheme, a UE performs precoding of different layers/DMRS ports of one PUSCH separately to transmit them, from two different UE panels, simultaneously with one codeword (CW). Alternatively, for this scheme, support of two CWs and whether to simultaneously transmit from two different panels are under study.

For the single-DCI multi-panel simultaneous transmission PUSCH scheme using SDM, application of a single frequency network (SFN) transmission scheme is under study. In the SEN scheme, all same layers/DMRS ports of one PUSCH are transmitted from two different UE beams/panels simultaneously.

It is studied to support two SRS resource sets for CB or NCB, to support two TPMI fields with respect to two SRS resource sets (two panels/two TRPs), and to support two SRI fields with respect to two SRS resource sets (two panels/two TRPs). Furthermore, support of dynamic switching between an STxMP SDM scheme and single-TRP (STRP) transmission is under study. Note that the STRP transmission means that PUSCH transmission is associated with one panel/TRP/SRS resource set.

Dynamic Switching between STxMP SDM Scheme and STRP Transmission

For dynamic switching between the STxMP SDM scheme and STRP transmission, in a case where STxMP SDM is dynamically indicated, at least one of the following (1) and (2) is assumed.
(1) For a CB/NCB PUSCH, the first SRI field is associated with a first panel/TRP/SRS resource set and the second SRI field is associated with a second panel/TRP/SRS resource set.
(2) For a CB PUSCH, the first TPMI field is associated with the first panel/TRP/SRS resource set and the second TPMI field is associated with the second panel/TRP/SRS resource set.

Regarding indication of dynamic switching between STRP and STAMP, a specific field of DCI may be used. For example, at least one of the following (1) and (2) may be applied.
(1) Dynamic switching may be indicated to a UE by using an SRS resource set indication field. This may be similar to the SRS resource set indication field for the Rel-17 TDM MIRP PUSCH shown in FIG. 4. Any one of Example 1 to Example 4 as below may be applied.

In each example described below, STAMP (order of a first SRS resource set and a second SRS resource set) means that the first X layers are associated with the first SRS resource set and the rest of the layers are associated with the second SRS resource set. STxMP (order of the second SRS resource set and the first SRS resource set) means that the first X layers are associated with the second SRS resource set and the rest of the layers are associated with the first SRS resource set.

(Example 1) In a case of SRS resource set indication field =0, STRP (only the first SRS resource set) is indicated. In a case of SRS resource set indication field=1, STRP (only the second SRS resource set) is indicated. In a case of SRS resource set indication field=2, STxMP (order of the first SRS resource set and the second SRS resource set) is indicated. In a case of SRS resource set indication field=3, STAMP (order of the second SRS resource set and the first SRS resource set) is indicated.

(Example 2) In a case of SRS resource set indication field=0, STRP (only the first SRS resource set) is indicated. In a case of SRS resource set indication field=1, STRP (only the second SRS resource set) is indicated. In a case of SRS resource set indication field=2, STxMP (order of the first SRS resource set and the second SRS resource set) is indicated. SRS resource set indication field=3 is reserved (unused).

(Example 3) In a case of SRS resource set indication field=0, STRP (only the first SRS resource set) is indicated. In a case of SRS resource set indication field=1, STRP (only the second SRS resource set) is indicated. In a case of SRS resource set indication field=2, STxMP (order of the second SRS resource set and the first SRS resource set) is indicated. SRS resource set indication field=3 is reserved (unused).

(Example 4) It may be configured/indicated by RRC/MAC CE whether SRS resource set indication field=2 indicates STxMP (order of the first SRS resource set and the second SRS resource set) or STxMP (order of the second SRS resource set and the first SRS resource set).
(2) In a case where a joint TCI state/UL TCT state is configured, STRP or STXMP may be indicated by the number of joint TCI states/UL TCI states indicated. For example, in a case where two joint TCI states/UL TCI states are indicated, this indicates STxMP. In a case where one joint TCI state/UL TCI state is indicated, this indicates STRP.

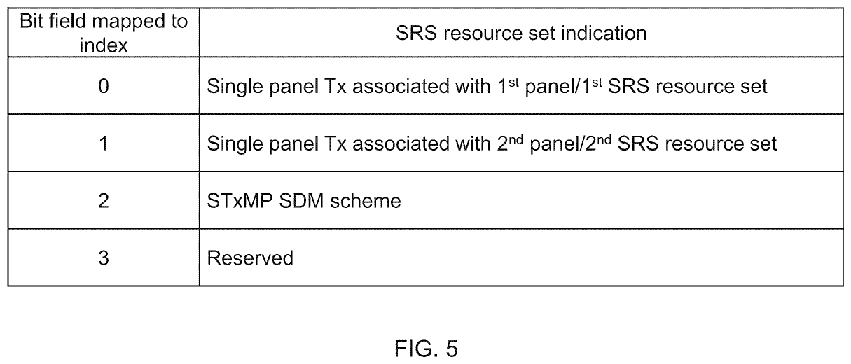

FIG. 5 is a diagram to show an example of an SRS resource set indication field to be applied to dynamic switching between a single-panel transmission scheme (STRP) and an STxMP SDM scheme. The example in FIG. 5 corresponds to Example 1 and Example 2 described above. In a case where dynamic switching between the STRP and STxMP SDM scheme is configured, the example in FIG. 5 may be applied to the SRS resource set indication field. In a case where such dynamic switching is not configured, the example in FIG. 4 (existing method) may be applied.

Hereinafter, as an example of a case where dynamic switching between the STxMP SDM scheme and STRP transmission is applied, first to third aspects will be described. Note that each aspect may be applied to an STAMP SFN scheme (for example, SDCI STAMP SEN PUSCH scheme). In other words, in each aspect, SDM may be interpreted as SFN.

### First Aspect

For a codebook (CB) based PUSCH, in a case where dynamic switching between a multi-panel simultaneous transmission SDM scheme (first scheme) and STRP transmission (scheme that PUSCH transmission is associated with one panel/TRP/SRS resource set (second scheme) is applied (configuration of such switching is received) and STRP transmission (second scheme) is dynamically indicated (indication indicating STRP (second scheme) is received), at least one of the following options may be applied.

### Option 1

In a case where STRP transmission associated with the first/second panel/TRP/SRS resource set is indicated, a UE may apply the first SRI field.

### Option 2

In a case where STRP transmission (second scheme) associated with the first or second panel/TRP/SRS resource set is indicated, each of the first SRI field and second SRI field is applied.

### Option 3

In a case where STRP transmission (second scheme) associated with the first or second panel/TRP/SRS resource set is indicated, an SRI field in a larger size may be applied.

### Option 4

In a case where STRP transmission (second scheme) associated with the first/second panel/TRP/SRS resource set is indicated, a UE may interpret the first/second SRI field as one field integrated.

### Second Aspect

For a codebook (CB) based PUSCH, in a case where dynamic switching between a multi-panel simultaneous transmission SDM scheme (first scheme) and STRP transmission (second scheme that PUSCH transmission is associated with one panel/TRP/SRS resource set) is applied (configuration of such switching is received) and STRP transmission (second scheme) is dynamically indicated (indication indicating STRP (second scheme) is received), at least one of the following options may be applied.

### Option 1

In a case where STRP transmission (second scheme) associated with the first/second panel/TRP/SRS resource set is indicated, a UE may apply the first TPMI field.

### Option 2

In a case where STRP transmission (second scheme) associated with the first or second panel/TRP/SRS resource set is indicated, each of the first TPMI field and second TPMI field is applied.

### Option 3

In a case where STRP transmission (second scheme) associated with the first/second panel/TRP/SRS resource set is indicated, a UE may interpret the first/second TPMI field as one field integrated.

### Third Aspect

For a non-codebook (NCB) based PUSCH, in a case where dynamic switching between a multi-panel simultaneous transmission SDM scheme (first scheme) and STRP transmission (second scheme that PUSCH transmission is associated with one panel/TRP/SRS resource set) is applied (configuration of such switching is received) and STRP transmission (second scheme) is dynamically indicated (indication indicating STRP (second scheme) is received), at least one of the following options may be applied.

### Option 1

In a case where STRP transmission (second scheme) associated with the first/second panel/TRP/SRS resource set is indicated, a UE may apply the first SRI field.

### Option 2

In a case where STRP transmission (second scheme) associated with the first or second panel/TRP/SRS resource set is indicated, each of the first SRI field and second SRI field is applied.

### Option 3

In a case where STRP transmission (second scheme) associated with the first/second panel/TRP/SRS resource set is indicated, a UE may interpret the first/second SRI field as one field integrated.

### Analysis

As described above, in future radio communication systems (for example, NR), a terminal is possible to use one of a plurality of panels (beams) for UL transmission. For example, a single-DCI multi-panel simultaneous transmission PUSCH using space division multiplexing (SDM) (SDCI STXMP SDM PUSCH) or a single-DCI multi-panel simultaneous transmission PUSCH using SEN (SDCI STxMP SEN PUSCH) is applied.

However, studies have not sufficiently been made on control for a case that simultaneous transmission using a plurality of panels is supported. For example, in a case where a configured grant is applied, regarding a single-DCI multi-panel simultaneous transmission PUSCH, what configuration/control is to be made has not sufficiently been studied. Unless this is made clear, system performance reduction such as a decrease in throughput may be caused.

For example, in Rel. 17, for a type 1 CG, an SRI and a TPMI are configured in configuredGrantConfiguration. For a type 2 CG, an SRI and a TPMI are indicated in DCI for activation. For the type 1 CG, in a case of retransmitting a PUSCH, an SRI and a TPMI are indicated in scheduling DCI for re-transmission.

Configuration/interpretation and the like of these fields for a case of applying an SDCI STxMP SDM/SEN PUSCH are not clear.

In view of this, the inventors of the present invention came up with the idea of a method of appropriately controlling a single-DCI multi-panel simultaneous transmission PUSCH in a case where a configured grant is applied.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, notify, activate, deactivate, indicate (or specify), select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or any combination of Radio Resource Control (RRC) signaling, Medium Access Control (MAC) signaling, broadcast information, other messages (for example, a messages from a core network such as a positioning protocol (for example, NR Positioning Protocol A (NRPPa)/LTE Positioning Protocol (LPP)) message), and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, STxMP, multi-panel simultaneous transmission, multi-panel simultaneous UL transmission, and multi-panel simultaneous (UL) transmission using multi-DCI may be interchangeably interpreted. The multi-panel simultaneous transmission may mean that a plurality of UL transmissions are made simultaneously from a plurality of panels. “Simultaneous” may mean that at least a part of the plurality of UL transmissions has a temporal overlap. In the present disclosure, supporting and being configured/indicated may be interchangeably interpreted. In the present disclosure, transmit power and output power may be interchangeably interpreted. In the present disclosure, determination by a UE and configuration/indication by a network (base station/gNB) may be interchangeably interpreted.

In the present disclosure, a panel, a panel ID, a TRP, a UE capability value index, a UE capability value set, a ICI state, an SRI, an SRS resource set, an SRS resource set ID, a CORESET pool index (CORESETPool Index), a layer group, an antenna port group, a beam, and a TCI state may be interchangeably interpreted. In the present disclosure, a case that two PUSCHs (PUSCH transmissions) have an overlap may mean that at least a part of the two PUSCHs (PUSCH transmissions) has a temporal overlap.

Configuration of multi-panel simultaneous transmission may mean that a plurality of pieces of DCI associated with different ones of CoresetPoolIndex schedule different PUSCHs. A plurality of PUSCHs associated with different ones of CoresetPoolIndex/panels and a plurality of PUSCHs scheduled by a plurality of pieces of DCI associated with different ones of CoresetPoolIndex/panels may be interchangeably interpreted.

Reception of configuration of multi-panel simultaneous transmission using multi-DCI and configuration of multi-panel simultaneous transmission may be interchangeably interpreted. DCI for activation and activation DC may be interchangeably interpreted.

In the present disclosure, a first/second SRS resource set may correspond to an SRS resource set with a low/high ID. The single-TRP (STRP) transmission means that PUSCH transmission is associated with one panel/TRP/SRS resource set. The STxMP SDM (STxMP SDM scheme) means that different layers for a PUSCH are associated with the respective different panels/TRPs/SRS resource sets.

### Radio Communication Method

A UE receives (is configured with) configuration information of a type 1/type 2 configured grant and two sounding reference signal (SRS) resource sets. Then the UE may control a single-DCI multi-panel simultaneous transmission physical uplink shared channel (PUSCH) using space division multiplexing (SDM) or a single frame network (SFN). Hereinafter, cases will be described in detail.

### First Embodiment

A first embodiment describes processing for a case where a type 1 configured grant (CG) is configured, two SRS resource sets (codebook/non-codebook SRS resource sets) are configured, and a scheme of space division multiplexing for a single-DCI multi-panel simultaneous transmission PUSCH (SDCI STxMP SDM PUSCH scheme) is performed. In this case, a UE may receive configuration information indicating the SDCI STxMP SDM PUSCH scheme by using higher layer signaling. In the present disclosure, a first/second SRS resource set may be interpreted as an SRS resource set with a low (lowest)/high (highest) ID.

### Option 1

At default, configuration of the SDCI STxMP SDM PUSCH is not applied to the type 1 CG. In other words, in a case where the type 1 CG is configured, the UE is not able to perform SDCI STxMP SDM PUSCH transmission. The type 1 CG performs STRP transmission. The UE expect that ConfiguredGrantConfig includes one field of srs-ResourceIndicator and one field of precodingAndNumberOfLayers.

### Option 1-1

At default, PUSCH transmission is associated with the first SRS resource set.

### Option 1-2

Whether the PUSCH transmission is associated with the first SRS resource set or associated with the second SRS resource set may be configured in configuration information for the configured grant (ConfiguredGrantConfig). For example, an SRS resource set ID is configured in ConfiguredGrantConfig.

### Option 2

At default, configuration of the SDCI STAMP SDM PUSCH is applied to the type 1 CG. In other words, in a case where the type 1 CG is configured, the UE performs SDCI STxMP SDM PUSCH transmission.

The UE expect that ConfiguredGrantConfig includes two fields of srs-ResourceIndicator (srs-ResourceIndicator and srs-ResourceIndicator2) and two fields of precodingAndNumberOfLayers (precodingAndNumberOfLayers and precodingAndNumberOfLayers2).

The two fields of srs-ResourceIndicator/precodingAndNumberOfLayers described above are associated with the respective separate SRS resource sets. In other words, srs-ResourceIndicator/precodingAndNumberOfLayers is associated with the first SRS resource set. srs-ResourceIndicator2/precodingAndNumberOfLayers2 is associated with the second SRS resource set.

### Option 3

In a case where configuredGrantConfig includes two fields of srs-ResourceIndicator (srs-ResourceIndicator and srs-ResourceIndicator2) and two fields of precodingAndNumberOfLayers (precodingAndNumberOfLayers and precodingAndNumberOfLayers2), the UE performs STxMP SDM PUSCH transmission. In this case, association of the two fields of srs-ResourceIndicator/precodingAndNumberOfLayers with an SRS resource set may be similar to that of Option 2.

In a case where the type 1 CG is configured and configuredGrantConfig includes one field of srs-ResourceIndicator and one field of precodingAndNumberOfLayers, the UE may perform single-TRP transmission. In this case, association of PUSCH transmission with an SRS resource set is similar to that of Option 1-1/Option 1-2.

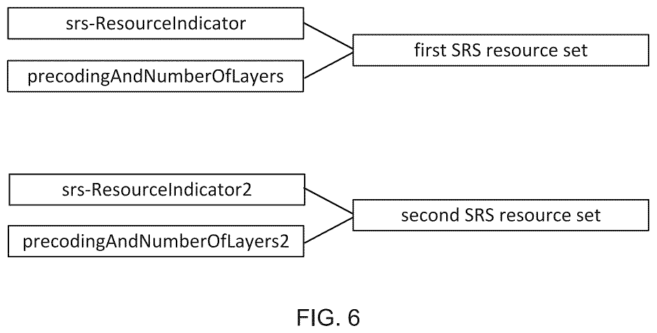

FIG. 6 is a diagram to show an example of associations in Option 2 and Option 3 according to the first embodiment. As shown in FIG. 6, srs-ResourceIndicator/precodingAndNumberOfLayers is associated with the first SRS resource set. Srs-ResourceIndicator2/precodingAndNumberOfLayers2 is associated with the second SRS resource set.

Although the first embodiment is described premised on a case that the type 1 CG is configured, this may be similarly applied to a case that the type 2 CG is configured.

The first embodiment enables the UE to appropriately control the SDCI STxMP SDM PUSCH scheme in a case where the type 1 CG and two SRS resource sets are configured.

### Second Embodiment

The first embodiment may be applied to a case that an SDCI STxMP SEN PUSCH scheme is configured. In other words, in the first embodiment, SDM may be interpreted as SFN.

### Third Embodiment

A third embodiment describes processing for a case where, in a type 2 configured grant (CG), two SRS resource sets (codebook/non-codebook SRS resource sets) are configured and the SDCI STAMP SDM/SFN PUSCH scheme is performed. Note that a UE may receive configuration information indicating the SDCI STxMP SDM/SFN PUSCH scheme by using higher layer signaling.

Note that the first and second TPMI fields may each be interpreted as a “Precoding information and number of layers” field or a second “Precoding information” field in DCI.

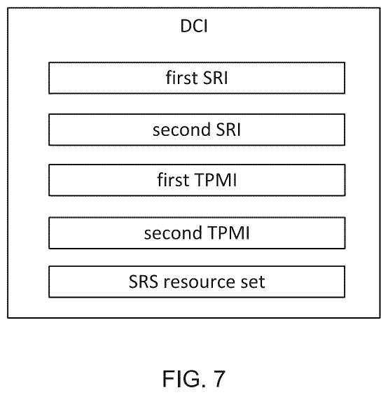

In a case where the UE receives DCI that activates a CG and the DCI includes two SRI fields, two TPMI fields, and an SRS resource set indication field (FIG. 7), the UE may interpret/apply each SRI field/TPMI field/SRS resource set indication field similarly to a case of a dynamic grant PUSCH.

In this case, the UE may interpret/apply, similarly to a case of a dynamic grant PUSCH, how the SRS resource set indication field indicates dynamic switching between an STRP and an STxMP SDM PUSCH or how the SRS resource set indication field indicates dynamic switching between an STRP and an STxMP SEN PUSCH. The UE judges, similarly to a case of a dynamic grant PUSCH, whether to apply/how to interpret the first/second SRI field/TPMI field.

Note that, in the present embodiment, the processing in each aspect (dynamic switching between the STAMP SDM scheme and STRP transmission) described above may be applied.

In a case where the DCI that activates the CG includes one SRI field, the DCI may include one TPMI field (for example, DCI format 0_0 is used). PUSCH transmission may be associated with the first SRS resource set. In this case, the UE performs PUSCH transmission with respect to a single TRP.

The third embodiment enables the UE to appropriately control the SDCI STxMP SDM/SEN PUSCH scheme and to control dynamic switching between the STRP and STxMP SEN PUSCH, in a case where the type 2 CG and two SRS resource sets are configured.

### Fourth Embodiment

The third embodiment may be applied to a type 1 configured CG. For example, “type 2 configured grant (CG)” in the third embodiment may be interpreted as “retransmission (retransmission of a PUSCH) in the type 1 configured CG.” Furthermore, “DCI for activation” may be interpreted as “scheduling DCI (DCI that schedules retransmission of a PUSCH).”

### Fifth Embodiment

### Embodiment 5-1

A case of PUSCH transmission of the type 1 CG in the STxMP SDM scheme will be described. A network indicates a DMRS port for SDM transmission by using an “antennaPort” field in configuration information for a configured grant (ConfiguredGrantConfig). A UE determines a DMRS port for SDM transmission, based on the “antennaPort” field in ConfiguredGrantConfig.

Description will be made on an example of a case where the total number of layers indicated by two precodingAndNumberOfLayers fields (precodingAndNumberOfLayers and precodingAndNumberOfLayers2) in ConfiguredGrantConfig for a CB based PUSCH two srs-ResourceIndicator fields (srs-ResourceIndicator and srs-ResourceIndicator2) in ConfiguredGrantConfig for an NCB based PUSCH is assumed to be L.

In a case where a CB based PUSCH is configured, the first L1 ports of DMRS ports indicated are associated with L1 PUSCH layers indicated by a first precodingAndNumberOfLayers field (precodingAndNumberOfLayers), and the rest L-L1layers of the DMRS ports indicated are associated with L-L1 PUSCH layers indicated by a second precodingAndNumberOfLayers field (precodingAndNumberOfLayers2).

In a case where an NCB based PUSCH is configured, the first L1 ports of DMRS ports indicated are associated with L1 PUSCH layers indicated by a first srs-ResourceIndicator field (srs-ResourceIndicator), and the rest L-L1 are associated with L-L1 PUSCH layers indicated by a second srs-ResourceIndicator field (srs-ResourceIndicator2) of the NCB based PUSCH.

In a case of applying PUSCH transmission of the type 1 CG in the STxMP SDM scheme, a DMRS port for SDM transmission can be indicated without adding any new parameter.

### Embodiment 5-2

A case of retransmission of the type 2 CG or type 1 CG in the STxMP SDM scheme will be described. DMRS port indication may be the same as that of a dynamic grant PUSCH. In order to indicate a DMRS port for SDM transmission, an “antennaPort” field in DCI may be used. A UE determines a DMRS port for SDM transmission, based on the “antennaPort” field in configuration information for a configured grant (ConfiguredGrantConfig). In the present disclosure, “DCI for activation” may mean DCI that activates the type 2 CG and “scheduling DCI” may mean DCI that schedules PUSCH retransmission of the type 1 CG.

Description will be made on an example of a case where the total number of layers indicated by two TPMI fields in DCI for activation/scheduling DCI for a CB based PUSCH or two SRI fields in DCI for activation/scheduling DCI for an NCB based PUSCH is assumed to be L.

In a case where a CB based PUSCH is configured, the first L1 ports of DMRS ports indicated are associated with LI PUSCH layers indicated by the first TPMI field, and the rest L-L1 of the DMRS ports indicated are associated with L-L1 PUSCH layers indicated by the second TPMI field.

In a case where an NCB based PUSCH is configured, the first Il ports of DMRS ports indicated are associated with L1 PUSCH layers indicated by the first SRI field, and the rest L-L1 of the DMRS ports indicated are associated with L-L1 PUSCH layers indicated by the second SRI field.

In a case of applying retransmission of the type 2 CG or type 1 CG in the STxMP SDM scheme, a DMRS port for SDM transmission can be indicated without adding any new parameter.

### Supplements

In the fifth embodiment, L1 described above may be defined in a specification or may be configured/indicated, for a UE, by higher layer signaling/physical layer signaling. For example, L1 may be L1=floor (L/2).

Association between a DMRS port indicated, L1 PUSCH Layers indicated by the first/second SRI field, and L1 PUSCH layers indicated by the first/second TPMI field may be directly indicated by higher layer signaling/physical layer signaling.

### Supplements

Notification of Information to UE Notification of any information to a UE (from a network (NW) (for example, a base station (BS))) (in other words, reception of any information from the BS in the UE) in the above-described embodiments may be performed by using physical layer signaling (for example, DCI), higher layer signaling (for example, RRC signaling, MAC CE), a specific signal/channel (for example, a PDCCH, a PDSCH, a reference signal), or a combination of these.

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary identifier (RNTI) used for scrambling of cyclic redundancy check (CRC) bits given to the DCI, a format of the DCI, or the like.

Notification of any information to a UE in the above-described embodiments may be performed periodically, semi-persistently, or aperiodically.

Notification of Information from UE

Notification of any information from a UE (to an NW) (in other words, transmission/reporting of any information to the BS from the UE) in the above-described embodiments may be performed by using physical layer signaling (for example, UCI) , higher layer signaling (for example, RRC signaling, MAC CE), a specific signal/channel (for example, a PUCCH, a PUSCH, a PRACH, a reference signal), or a combination of these.

When the notification is performed by a MAC CE, the MAC CE may be identified by a new LCID not defined in existing standards being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### Regarding Application of Each Embodiment

At least one of the above-described embodiments may be applied to a case satisfying a specific condition. The specific condition may be defined in a standard, or a UE/BS may be notified of the specific condition by using higher layer signaling/physical layer signaling.

At least one of the above-described embodiments may be applied only to a UE that has reported a specific UE capability or that supports the specific UE capability.

The specific UE capability may indicate at least one of the following:
supporting of specific processing/operation/control/information for at least one of the above-described embodiments
supporting of STxMP
supporting of SDCI STAMP SDM.
supporting of SDCI STxMP SEM
the number of DMRS ports in the STxMP SDM scheme
the values of L and L1

The specific UE capability may be capability applied over all the frequencies (commonly irrespective of frequency), capability per frequency (for example, one or a combination of cell, band, band combination, BWP, component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied when the UE is configured/activated/triggered with specific information related to the above-described embodiment (or performance of the operation of the above-described embodiment) by higher layer signaling/physical layer signaling. For example, the specific information may be information indicating that SDCI STxMP SDM/SFN is enabled, any RRC parameter for a specific release (for example, Rel. 18/19), or the like.

In a case where the UE does not support at least one of the specific UE capabilities described above or is not configured with the specific information, operation of Rel. 15/16 may be applied, for example.

### Supplementary Note

Regarding one embodiment of the present disclosure, the following supplementary notes of the invention will be given.

### Supplementary Note 1

A terminal including:
a receiving section that receives configuration information of a type 1 configured grant and two sounding reference signal (SRS) resource sets; and
a control section that controls a single-DCI multi-panel simultaneous transmission physical uplink shared channel (PUSCH) using space division multiplexing (SDM) or a single frame network (SEN).

### Supplementary Note 2

The terminal according to supplementary note 1, wherein
at least one of an SRS resource indicator field and a precoding and number of layers field is associated with a first SRS resource set, and
at least one of an SRS resource indicator 2 field and a precoding and number of layers 2 field is associated with a second SRS resource set.

### Supplementary Note 3

The terminal according to supplementary note 1 or 2, wherein
the receiving section receives downlink control information (DCI) that schedules retransmission of a PUSCH in a type 1configured grant,
the DCI includes two SRS resource indicator (SRI) fields, two transmitted precoding matrix indicator (TPMI) fields, and an SRS resource set indication field, and
the control section interprets the two SRI fields, the two TPMI fields, and the SRS resource set indication field similarly to a case of a dynamic grant PUSCH.

### Supplementary Note 4

The terminal according to any one of supplementary notes 1 to 3, wherein
the receiving section receives configuration information of a configured grant, and
the control section determines, based on an antenna port field in the configuration information, a demodulation reference signal (DMRS) port for SDM transmission.

### Supplementary Note

Furthermore, regarding one embodiment of the present disclosure, the following supplementary notes of the invention will be given.

### Supplementary Note 1

A terminal including:
a receiving section that receives configuration information of a type 2 configured grant and two sounding reference signal (SRS) resource sets; and
a control section that controls a single-DCI multi-panel simultaneous transmission physical uplink shared channel (PUSCH) using space division multiplexing (SDM) or a single frame network (SFN).

### Supplementary Note 2

The terminal according to supplementary note 1, wherein
the receiving section receives downlink control information (DCI) that activates a type 2 configured grant,
the DCI includes two SRS resource indicator (SRI) fields, two transmitted precoding matrix indicator (TPMI) fields, and an SRS resource set indication field, and
the control section interprets the two SRI fields, the two TPMI fields, and the SRS resource set indication field similarly to a case of a dynamic grant PUSCH.

### Supplementary Note 3

The terminal according to supplementary note 1 or 2, wherein
the receiving section receives configuration information of a configured grant, and
the control section determines, based on an antenna port field in the configuration information, a demodulation reference signal (DMRS) port for SDM transmission.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

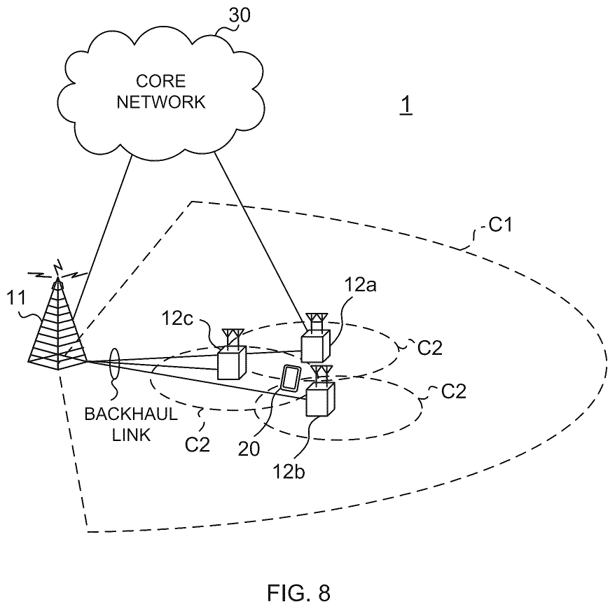

FIG. 8 is a diagram to show an example of a schematic structure of the radio communication system according to one embodiment. The radio communication system 1 (which may be simply referred to as system 1) may be a system implementing communication using Long Term Evolution (LTE), 5th generation mobile communication system New Radio (5G NR), or the like the specifications of which have been drafted by Third Generation Partnership Project (3GPP).

The radio communication system 1 may support dual connectivity (multi-RAT dual connectivity (MR-DC) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (qNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell Cl of a relatively wide coverage, and base stations 12 (12a to 12c) that form small cells C2, which are placed within the macro cell Cl and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCS).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FRI may be a frequency band of 6 GHz or less (sub-6 GHz), and FR2 may be a frequency band which is higher than 24 GHz (above-24 GHZ). Note that frequency bands, definitions and so on of FRI and FR2 are by no means limited to these, and for example, FRI may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface, or the like) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.” The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NFs) such as a User Plane Function (UPF), an Access and Mobility management Function (AMF), a Session Management Function (SMF), Unified Data Management (UDM), an Application Function (AF), a Data Network (DN), a Location Management Function (LMF), and maintenance operation management (Operation, Administration and Maintenance (Management) (CAM)), for example. Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-S-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

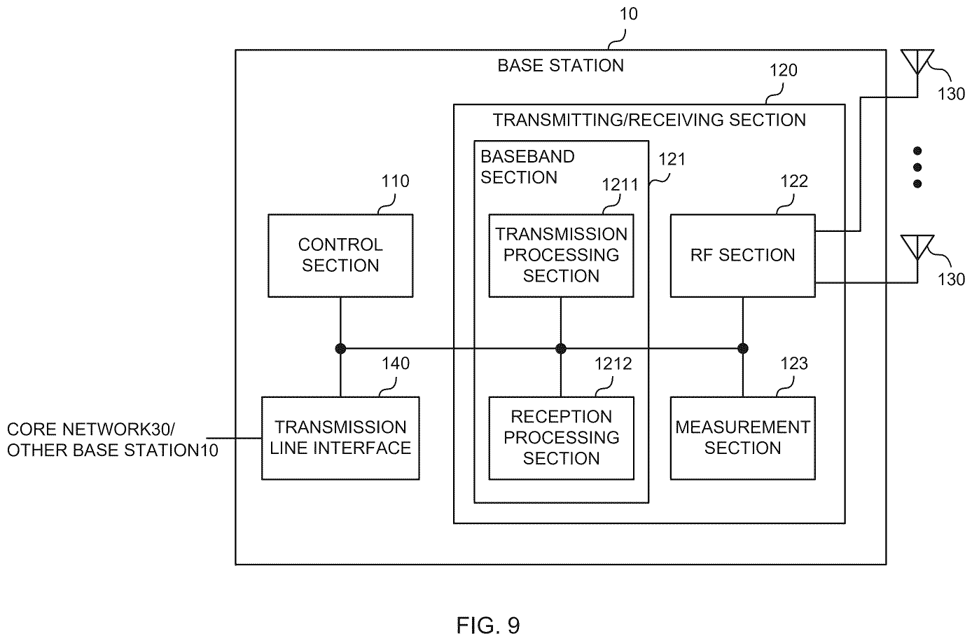

Base Station FIG. 9 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DET) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 (for example, a network node providing NF), another base station 10, or the like, and perform acquisition, transmission, or the like of user data (user plane data), control plane data, and the like for the user terminal 20.

Note that the transmitting section and the receiving section of the base station 10 in the present disclosure may be constituted with at least one of the transmitting/receiving section 120, the transmitting/receiving antennas 130, and the Communication path interface 140.

The transmitting/receiving section 120 may transmit configuration information of a type 1 configured grant and two sounding reference signal (SRS) resource sets.

The transmitting/receiving section 120 may transmit configuration information of a type 2 configured grant and two sounding reference signal (SRS) resource sets.

The control section 110 may control reception of a single-DCI multi-panel simultaneous transmission physical uplink shared channel (PUSCH) using space division multiplexing (SDM) or a single frame network (SEN).

### User Terminal

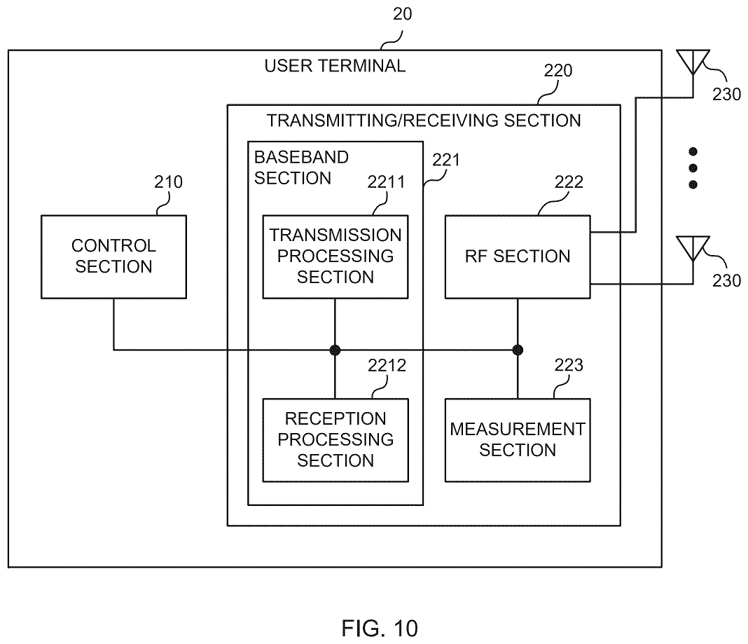

FIG. 10 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DET processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDET processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the measurement section 223 may derive channel measurement for CSI calculation, based on a resource for channel measurement. Examples of the resource for channel measurement may include a non-zero power (Non Zero Power (NZP)) CSI-RS resource. The measurement section 223 may derive interference measurement for CSI calculation, based on a resource for interference measurement. Such a resource for interference measurement may be at least one of an NZP CSI-RS resource for interference measurement, a CSI-interference measurement (CSI-IM) resource, and the like. Note that the CSI-IM may be referred to as CSI-interference management (CSI-IM) and that the CSI-IM and a zero power (ZP) CSI-RS may be interchangeably interpreted. Note that, in the present disclosure, a CSI-RS, an NZP CSI-RS, a ZP CSI-RS, CSI-IM, a CSI-SSB, and the like may be interchangeably interpreted.

Note that the transmitting section and the receiving section of the user terminal 20 in the present disclosure may be constituted with at least one of the transmitting/receiving section 220 and the transmitting/receiving antennas 230.

The transmitting/receiving section 220 may receive configuration information of a type 1 configured grant and two sounding reference signal (SRS) resource sets.

The control section 210 may control a single-DCI multi-panel simultaneous transmission physical uplink shared channel (PUSCH) using space division multiplexing (SDM) or a single frame network (SFN).

At least one of an SRS resource indicator field and a precoding and number of layers field may be associated with a first SRS resource set, and at least one of an SRS resource indicator 2 field and a precoding and number of layers 2 field may be associated with a second SRS resource set.

The transmitting/receiving section 220 may receive downlink control information (DCI) that schedules retransmission of a PUSCH in a type 1 configured grant. The DCI may include two SRS resource indicator (SRI) fields, two transmitted precoding matrix indicator (TPMI) fields, and an SRS resource set indication field. The control section 210 may interpret the two SRI fields, the two TPMI fields, and the SRS resource set indication field similarly to a case of a dynamic grant PUSCH.

The transmitting/receiving section 220 may receive configuration information of a configured grant. The control section 210 may determine, based on an antenna port field in the configuration information, a demodulation reference signal (DMRS) port for SDM transmission.

The transmitting/receiving section 220 may receive configuration information of a type 2 configured grant and two sounding reference signal (SRS) resource sets.

The transmitting/receiving section 220 may receive downlink control information (DCI) that activates the type 2 configured grant. The DCI may include two SRS resource indicator (SRI) fields, two transmitted precoding matrix indicator (TPMI) fields, and an SRS resource set indication field. The control section 210 may interpret the two SRI fields, the two TPMI fields, and the SRS resource set indication field similarly to a case of a dynamic grant PUSCH.

The transmitting/receiving section 220 may receive configuration information of a configured grant. The control section 210 may determine, based on an antenna port field in the configuration information, a demodulation reference signal (DMRS) port for SDM transmission.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

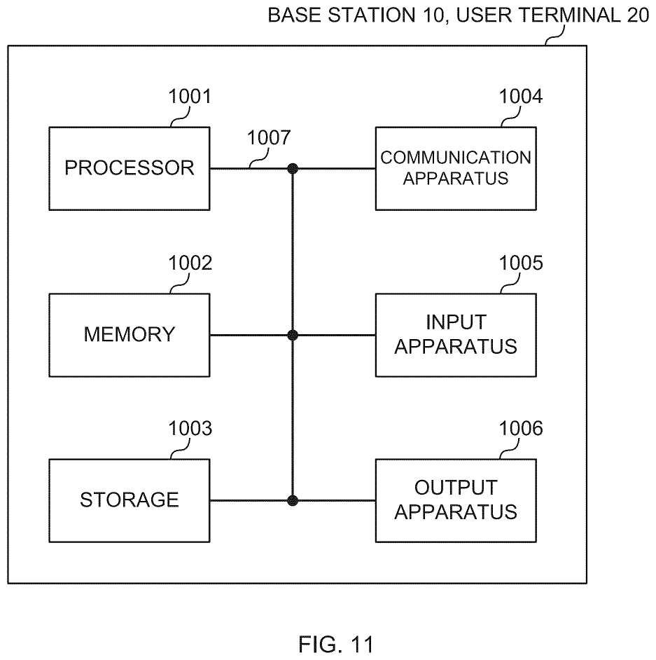

For example, a base station, a user terminal, and so on according to one embodiment of the present disclosure may function as a computer that executes the processes of the radio communication method of the present disclosure. FIG. 11 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part of all of the functional blocks may be implemented by the hardware. For example, the processor 1001 may be implemented with at least one of these pieces of hardware.

### Variations

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot.

A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRE pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRE may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message” and can be, for example, an RRC connection setup message, an RRC connection reconfiguration message, and so on. Also, MAC signaling may be notified using, for example, MAC control elements (MAC CES).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e. g., comparison with a certain value).

Software, irrespective of whether referred to as “software”, “firmware” , “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, a “layer”, “the number of layers”, a “rank”, a “resource”, a “resource set” a “beam”, a “beam width”, a “beam angular degree”, an “antenna” an “antenna element”, a “panel”, a “UE panel”, a “transmission entity”, a “reception entity”, and so on may be used interchangeably.

Note that, in the present disclosure, the “antenna port” may be used interchangeably with an “antenna port for an arbitrary signal/channel” (for example, a demodulation reference signal (DMRS) port). In the present disclosure, the “resource” may be used interchangeably with a “resource for an arbitrary signal/channel” (e. g., a reference signal resource, an SRS resource, and the like). The resource may include time/frequency/code/space/power resource. The spatial domain transmission filter may include at least one of a spatial domain transmission filter and a spatial domain reception filter.

The group may include at least one of, for example, a spatial relationship group, a code division multiplexing (CDM) group, a reference signal (RS) group, a control resource set (CORESET) group, a PUCCH group, an antenna port group (for example, a DMRS port group), a layer group, a resource group, a beam group, an antenna group, a panel group, and the like.

In the present disclosure, a “beam”, an “SRS resource indicator (SRI)”, a “CORESET”, a “CORESET pool”, a “PDSCH”, a “PUSCH”, a “codeword (CW)”, a “transport block (TB)”, an “RS”, and the like may be interchangeably used.

In the present disclosure, a “TCI state”, a “downlink TCI state (DL TCI state)”, an “uplink TCI state (UL TCI state)” a “unified TCI state”, a “common TCI state”, a “joint TCI state” and the like may be used interchangeably.

In the present disclosure, “QCL”, “QCL assumption”, “QCL relationship”, “QCL type information”, “QCL property/properties”, “specific QCL type (e. g., type A, type D) property”, “specific QCL type (e.g., type A, type D)”, and the like may be used interchangeably.

In the present disclosure, an=“index”, an “identifier (ID)”, an “indicator”, “indication”, a “resource ID”, and the like may be used interchangeably. In the present disclosure, a sequence, a list, a set, a group, a cluster, a subset, and the like may be used interchangeably.

### A Spatial Relation Information Identifier (ID) (TCI State ID)

and spatial relation information (TCI state) may be interchangeably used. “Spatial relation information (TCI state)” may be used interchangeably with “a set of spatial relation information (TCI state)”, “one or a plurality of spatial relation information”, and the like. The TCI state and the TCI may be used interchangeably. The spatial relation information and the spatial relation may be used interchangeably.

In the present disclosure, the terms such as a “base station (BS)”, a “radio base station”, a “fixed station,” a “NodeB”, an “eNB (eNodeB)”, a “qNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and So on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type).

Note that at least one of a base station and a mobile station also includes an apparatus which does not necessarily move during communication operation. For example, at least one of a base station and a mobile station may be an Internet of Things (IOT) device such as a sensor.

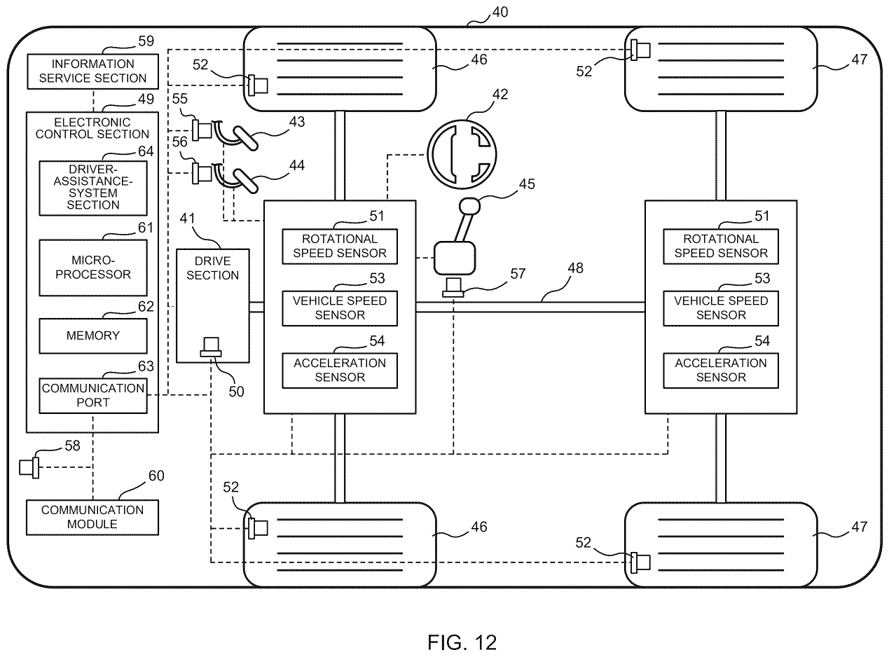

FIG. 12 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LIDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUS that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LIE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)” about some action. In the present disclosure, “decide/deciding (determine/determining)” may be interchangeably interpreted as the above-described actions.

In the present disclosure, “decide/deciding (determine/determining)” may be used interchangeably with “assume/assuming”, “expect/expecting”, “consider/considering”, and the like. Note that, in the present disclosure, “not expect to” may be used interchangeably with “expect not to”.

In the present disclosure, “expect” may be used interchangeably with “be expected”. For example, “expect(s) . . . ” (“ . . . ” may be expressed using, for example, a that-clause, a to-infinitive, or the like) may be used interchangeably with “be expected . . . ”. “Does not expect . . . ” may be used interchangeably with “be not expected . . . ” . Furthermore, “an apparatus A is not expected . . . ” may be used interchangeably with “an apparatus B other than the apparatus A does not expect . . . for the apparatus A” (for example, when the apparatus A is a UE, the apparatus B may be a base station).

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a” , “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”. “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best”may be used interchangeably with “i-th best”, and vice versa).

In the present disclosure, “of”, “for”, “regarding”, “related to”, “associated with”, and the like may be used interchangeably.

In the present disclosure, “when A, B”, “if A, (then) B”, “B upon A”, “B in response to A”, “B based on A”, “B during/while A”, “B before A”, “B (at the same time as) /on A”, “B after A”, “B since A”, “B until A”, and the like may be used interchangeably.

Note that A and B here may be replaced with appropriate expressions such as nouns, dynamic nouns, and normal sentences, as appropriate, depending on the context. The time difference between A and B may be substantially 0 (immediately after or immediately before). A time offset may be applied to the time at which A occurs. For example, “A” may be used interchangeably with “before/after the time offset at which A occurs”. The time offset (for example, one or more symbols/slots) may be defined in advance or may be specified by the UE based on the notified information.

In the present disclosure, timing, time point, time, time instance, any time unit (e.g., slot, sub-slot, symbol, subframe), period, occasion, a resource, or the like may be used interchangeably.

Now, although the invention according to the present disclosure has been described in detail above, it is apparent to a person skilled in the art that the invention according to the present disclosure is by no means limited to the embodiments described in the present disclosure. The description of the present disclosure is provided only for the purpose of explaining examples, and should by no means be construed to limit the invention according to the present disclosure in any way.

1-6. (canceled)

7. A terminal comprising:
a receiver that receives configured grant information for configuring a first type of configured grant, and sounding reference signal (SRS) resource set information for configuring two SRS resource sets; and
a processor that controls to perform multiple panel simultaneous transmission of a physical uplink shared channel (PUSCH) using a space division multiplexing (SDM) scheme or a single frame network (SFN) scheme.

8. The terminal according to claim 7, wherein the configured grant information includes a first parameter indicating an SRS resource indicator (SRI) associated with a first SRS resource set and a second parameter indicating an SRI associated with a second SRS resource set.

9. A radio communication method for a terminal, comprising:
receiving configured grant information for configuring a first type of configured grant, and sounding reference signal (SRS) resource set information for configuring two SRS resource sets; and
controlling to perform multiple panel simultaneous transmission of a physical uplink shared channel (PUSCH) using a space division multiplexing (SDM) scheme or a single frame network (SFN) scheme.

10. A base station comprising:
a transmitter that transmits configured grant information for configuring a first type of configured grant, and sounding reference signal (SRS) resource set information for configuring two SRS resource sets; and
a processor that controls to receive multiple panel simultaneous transmission of a physical uplink shared channel (PUSCH) using a space division multiplexing (SDM) scheme or a single frame network (SFN) scheme.

11. A system comprising a terminal and a base station, wherein
the terminal comprises:
a receiver that receives configured grant information for configuring a first type of configured grant, and sounding reference signal (SRS) resource set information for configuring two SRS resource sets; and
a processor that controls to perform multiple panel simultaneous transmission of a physical uplink shared channel (PUSCH) using a space division multiplexing (SDM) scheme or a single frame network (SFN) scheme, and
the base station comprises:
a transmitter that transmits the configured grant information and the SRS resource set information.
